(19) United States
(12) Patent Application Publication
(10) Pub. No.: US 2015/0122120 A1
(43) Pub. Date: May 7, 2015

(54) HYDROGEN SULFIDE CONTROL IN BIODIGESTION PROCESSES

(71) Applicant: Geoffrey Lawrence Stensland, Lake Stevens, WA (US)

(72) Inventor: Geoffrey Lawrence Stensland, Lake Stevens, WA (US)

(21) Appl. No.: 14/532,623

(22) Filed: Nov. 4, 2014

Related U.S. Application Data
(60) Provisional application No. 61/900,233, filed on Nov. 5, 2013.

(51) Int. Cl. B01D 53/14

(52) U.S. Cl. CPC B01D 53/1468; B01D 53/1493; B01D 2252/20436
USPC 95/19; 95/235; 95/187; 95/149; 96/134; 96/113; 261/94

(57) ABSTRACT

Systems and methods for removing hydrogen sulfide from biogas resulting from anaerobic digestion of biodegradable waste utilize scrubbing vessels with pressure release devices to vent biogas when necessary to avoid over pressurization of the digesters. Use of iron containing sulfide scavengers in the digesters is avoided which avoids the disposal costs associated with iron containing sludge and the regular need to shut down the digesters to remove scale.

### BACKGROUND

1. Technical Field

The subject matter described herein relates to control and removal of hydrogen sulfide from biogas resulting from the digestion of waste containing biodegradable components.

2. Description of the Related Art

Hydrogen sulfide gas is an unwelcome by-product of anaerobic digestion of biodegradable waste in municipal and industrial facilities. Hydrogen sulfide is a noxious potentially deadly gas that is highly regulated by state and federal agencies throughout the United States and Canada. For example, there are significant fines if a high level release (e.g., >40 ppm) of hydrogen sulfide gas to the environment occurs. Many digesters for biodegradable waste are provided with pressure relief valves (PSV) that have set pressures set to protect the digester from an over pressurization event. If an over pressurization event occurs, the PSV vents biogas out of the digester, often into the environment. Left untreated, this biogas will have a hydrogen sulfide content that most surely will exceed prescribed limits. Furthermore, if the hydrogen sulfide containing biogas is combusted for energy, there is typically an upper limit to the level of sulfur oxide (SOₓ) from the combustion that can be released into the environment. When the hydrogen sulfide containing biogas will be delivered to a natural gas pipeline, the sulfide content of the biogas must be reduced to levels consistent with the hydrogen sulfide content of the natural gas in the pipelines.

Current digesters include a pressure relief valve to relieve pressure within the digester so that an over pressurization event can be avoided. Avoiding an over pressurization event is important because such event threatens the operational and physical integrity of the digester. With the possibility of pressure relief and venting of biogas from the digester at any time, it is critical that the hydrogen sulfide content of the biogas that may be released from the digester, be controlled to a level below the allowed limits for hydrogen sulfide content of biogas released to the environment. Current digesters reduce the amount of hydrogen sulfide content of the biogas that may be released to the environment by adding ferrous chloride to the digester sludge or to the biodegradable waste prior to delivery to the digester. A benefit of the ferrous chloride addition is that the amount of sulfide in the head space of the digester is kept at or below the allowed sulfide discharge limit. Thus, when a digester is vented, e.g., when the digester pressure exceeds predetermined limits, the level of sulfide in the biogas that is released from the digester is below the allowed limit. Adding ferrous chloride also removes sulfides that would otherwise result in sulfur oxides upon combustion of the biogas for energy production or disposal. Adding ferrous chloride also removes sulfides that would need to be removed by other means before delivering the sulfide containing biogas to a natural gas pipeline. Another advantage of choosing ferrous chloride as a means to manage hydrogen sulfide content of biogas is that ferrous chloride is not a toxin to the bacteria in the digesters and can be added upstream of the digesters.

Ferrous chloride is not without its disadvantages and problems. For example, use of ferrous chloride in digesters to control sulfide levels is costly, on the order of about $6 per pound of sulfur removed. Another disadvantage of using ferrous chloride to control sulfur levels is that the iron will react with phosphate in the water system and result in scale formation on equipment and piping which can degrade the performance and effectiveness of the equipment and piping. Scale that forms on equipment and piping must be removed periodically, at significant cost (e.g., on the order of $200,000 or more for a large plant). The direct and indirect costs of using ferrous chloride go beyond the cost of removing the scale and include the costs of disposing of the digester sludge which contains the heavy iron containing salts. For municipal plants, these disposal costs become even higher as disposal sites that accept iron containing sludge move further away from the municipal plants. In a large municipal plant, the additional cost to dispose of sludge due to the presence of iron containing salts can be on the order of $500,000 dollars per year or more.

FIG. 1 is a process flow diagram for a typical process that employs ferrous chloride to control the sulfide content of biogas resulting from anaerobic digestion of biodegradable waste. In FIG. 1, digestion of biodegradable waste occurs in digester 10 that includes a pressure relief valve (PSV) 12 and a flame arrestor. Pressure relief valve 12 has a set pressure above which the PSV opens, allowing biogas to vent from digester 10. Venting of the digester provides a safety mechanism to avoid an over pressurization event wherein pressure within the digester exceeds a limit that compromises the operational and/or physical integrity of the digester. Under normal operation, biogas from the anaerobic digestion of biodegradable waste in digester 10 exits digester 10 and is used in one or more ways. A portion of the biogas may be subjected to a gas cleanup process 14 to remove unwanted components prior to delivery of the treated biogas to a natural gas pipeline. Alternatively, or in addition, a portion of the biogas may be utilized to generate power via combustion of the biogas in a power generation process 16. In yet a third process, the biogas is combusted, e.g., via a flare 18. As described in the previous paragraph, in order to reduce the sulfide content of the biogas exiting the digester, ferrous chloride is introduced to the digester 10 or to the biodegradable waste prior to entry into digester 10. The ferrous chloride scavenges available sulfides, thus reducing the sulfide content of the biogas exiting digester 10.

With the ever increasing amounts of material processed by municipal and industrial waste plants and the increasing costs and sensitivity to disposing of digestion sludge in landfills, operators of waste facilities would be interested in systems and methods to reduce the sulfide content of biogas resulting from the anaerobic digestion of biodegradable waste that do not promote scale formation or produce large of amounts of iron-containing sludge that must be disposed of in faraway landfills and that also provide the necessary safety features to avoid over pressurization events within the digester.

### BRIEF SUMMARY

As an overview, embodiments of the subject matter described herein are useful in municipal and industrial plants that employ anaerobic digestion to treat biodegradable waste. Such plants produce biogas containing methane, carbon dioxide and hydrogen sulfide. The hydrogen sulfide content must be reduced in order to 1) avoid fines for violating environmental regulations in the event biogas having a hydrogen sulfide content above the allowed limits is released to the environment and (2) avoid producing amounts of sulfur oxides (SOₓ) above allowed limits when the biogas is combusted for power generation or to dispose of the biogas.

Embodiments of the subject matter described herein relate to a system for removing hydrogen sulfide from a hydrogen sulfide containing biogas resulting from an anaerobic digestion of waste containing biodegradable materials. Described systems include a scrubbing vessel and a scrubbing solution collector. The vessel includes an inlet for receiving hydrogen sulfide containing biogas produced by an anaerobic digestion of waste containing biodegradable materials, at least one media bed, at least one inlet for receiving a scrubbing solution, a pressure relief device, and an outlet for exhausting treated biogas. The scrubbing solution collector includes a scrubbing solution dispersion device, a first zone including the scrubbing solution dispersion device where hydrogen sulfide containing biogas resulting from an anaerobic digestion of waste containing biodegradable materials is contacted with dispersed scrubbing solution. The collector further includes a second zone in fluid communication with the vessel and in fluid communication with the first zone.

In certain embodiments, the pressure relief device has a set pressure that is less than about 13 inches of water.

In related embodiments wherein the hydrogen sulfide containing biogas results from the digestion of biodegradable materials in a digester that includes a pressure relief device, the pressure relief device of the scrubbing vessel has a set pressure that is at least about 1 inch of water less than a set pressure of the pressure relief device on the digester in which the anaerobic digestion that results in the hydrogen sulfide containing biogas occurs.

The pressure relief device of the scrubber vessel in other embodiments has a set pressure that is at least about 2 inches of water less than the set pressure of the pressure relief device for the digester in which the anaerobic digestion that produces the hydrogen sulfide containing biogas occurs.

The set pressure of the pressure release device for the digester in which the anaerobic digestion that produces the hydrogen sulfide containing biogas occurs is 13 inches of water in yet other embodiments.

In some embodiments, the scrubbing solution includes at least one of a triazine based compound, a thiadiazine based compound, and a dithiazine based compound.

In yet other embodiments, a source of scrubbing solution and a controller for controlling delivery of scrubbing solution to the vessel from the source of scrubbing solution are described.

In certain described embodiments, the pressure drop across the vessel ranges from about 1 to 5 inches of water.

In yet other described embodiments, the pressure drop across the vessel is less than or equal to 1 inch of water.

In some of the embodiments described herein, the vessel includes at least two media beds and/or a scrubbing solution recycle from the second zone to the vessel.

In yet other embodiments, the subject matter described herein relates to a method for removing hydrogen sulfide from a hydrogen sulfide containing biogas resulting from an anaerobic digestion of waste containing biodegradable materials. The described methods include the steps of receiving in a vessel, a hydrogen sulfide containing biogas resulting from anaerobic digestion of waste containing biodegradable materials, introducing into the vessel a scrubbing solution, contacting the biogas with the scrubbing solution, removing treated biogas from the vessel, and venting treated biogas from the vessel.

In certain describe embodiments the venting occurs when pressure in the vessel is less than about 13 inches of water.

In other described embodiments, the venting occurs when pressure in the vessel is at least about one inch or at least about two inches of water less than pressure in a reactor in which the anaerobic digestion that results in the hydrogen sulfide containing biogas occurs.

In some embodiments, the introducing step includes introducing at least one of a triazine-based compound, a thiadiazine based compound and a dithiazine based compound.

Other embodiments described herein include a step of collecting scrubbing solution from the vessel in a scrubbing solution collector and contacting the collected scrubbing solution with the hydrogen sulfide containing biogas resulting from the anaerobic digestion.

Recycling of collected scrubbing solution from the scrubbing solution collector to the vessel is described with respect to certain embodiments.

Other embodiments described herein include a step of separating the collected scrubbing solution into a recycled portion and a non-recycled portion.

In yet further embodiments, the non-recycled portion of collected scrubbing solution is described as being dispersed within the hydrogen sulfide containing biogas resulting from the anaerobic digestion prior to receiving the hydrogen sulfide containing biogas into the vessel.

In embodiments described herein, the liquid to gas ratio in the vessel ranges from about 5 to about 100.

Still other embodiments of the subject matter described herein relate to methods for relieving pressure in a process for the anaerobic digestion of waste containing biodegradable materials. The described methods include the steps of receiving in a vessel, a hydrogen sulfide containing biogas resulting from an anaerobic digestion of waste containing biodegradable materials, introducing a scrubbing solution into the vessel, contacting the biogas with the scrubbing solution, removing treated biogas from the vessel, and venting treated biogas from the vessel.

In some embodiments described herein, venting occurs when pressure in the vessel is less than about 13 inches of water.

In yet other embodiments, venting occurs when pressure in the vessel is at least about one inch or two inches of water less than pressure in a reactor in which the anaerobic digestion that results in the hydrogen sulfide containing biogas occurs.

Other embodiments are described wherein the introducing step includes introducing at least one of a triazine-based compound, a thiadiazine based compound and a dithiazine based compound.

Certain embodiments described collecting scrubbing solution from the vessel in a scrubbing solution collector and contacting the collected scrubbing solution with the hydrogen sulfide containing biogas produced by the anaerobic digestion.

Recycling of collected scrubbing solution from the scrubbing solution collector to the vessel is described in certain embodiments.

In yet other embodiments, the collected scrubbing solution is separated into a recycled portion and a non-recycled portion.

Some embodiments describe dispersing the non-recycled portion of collected solution within the hydrogen sulfide containing biogas resulting from the anaerobic digestion prior to receiving the hydrogen sulfide containing biogas into the vessel.

A liquid to gas ratio in the vessel ranging from about 5 to about 100 is described with respect to certain embodiments of the subject matter described herein.

In certain embodiments, the thiazine based compound is hexahydro-1,3,5-tris(2-hydroxyethyl)-s-triazine.

### BRIEF DESCRIPTION OF THE SEVERAL VIEWS OF THE DRAWINGS

In the drawings, identical reference numbers identify similar elements. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and they have been solely selected for ease of recognition in the drawings.

FIG. 1 is a process flow diagram for a process for removing hydrogen sulfide from biogas resulting from the anaerobic digestion of biodegradable waste using ferrous chloride and a digester that includes a pressure relief valve;

FIG. 2 is a process flow diagram for an embodiment of processes for removing hydrogen sulfide from biogas resulting from the anaerobic digestion of biodegradable waste described herein; and

FIG. 3 is a schematic diagram of an embodiment of systems for removing hydrogen sulfide from biogas resulting from the anaerobic digestion of biodegradable waste described herein.

### DETAILED DESCRIPTION

It will be appreciated that, although specific embodiments of the present disclosure are described herein for purposes of illustration, various modifications may be made without departing from the spirit and scope of the present disclosure. Accordingly, the present disclosure is not limited except as by the appended claims.

In the following description, certain specific details are set forth in order to provide a thorough understanding of various aspects of the disclosed subject matter. However, the disclosed subject matter may be practiced without these specific details. In some instances, well-known structures for carrying out, and methods, for anaerobically digesting biodegradable waste have not been described in detail to avoid obscuring descriptions of other aspects of the subject matter described herein. In some instances, well-known structures for carrying out, and methods, for scrubbing of contaminants from gases using liquids comprising embodiments of the subject matter disclosed herein have not been described in detail to avoid obscuring the descriptions of other aspects of the present disclosure.

Unless the context requires otherwise, throughout the specification and claims that follow, the word “comprise” and variations thereof, such as “comprises” and “comprising” are to be construed in an open, inclusive sense, that is, as “including, but not limited to.”

Reference throughout the specification to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Furthermore, the particular features, structures, or characteristics may be combined in any suitable manner in one or more aspects of the present disclosure.

In the figures, identical reference numbers identify similar features or elements. The sizes and relative positions of the features in the figures are not necessarily drawn to scale.

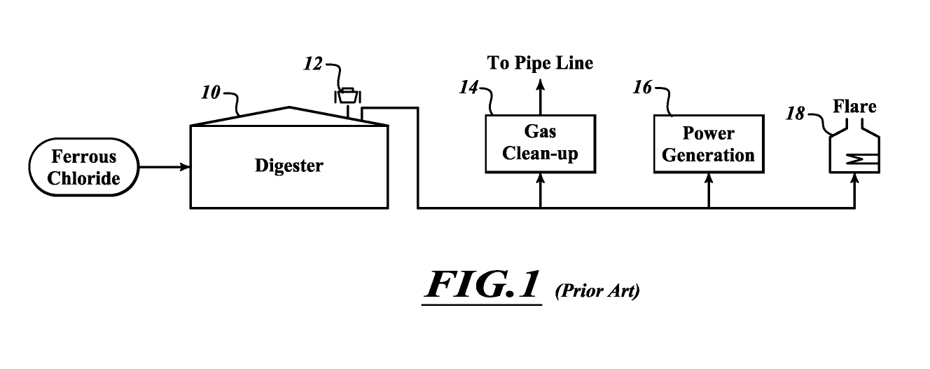

The embodiments of subject matter described herein provide a useful and cost-effective alternative to the use of ferrous chloride to control sulfide content in biogas resulting from the anaerobic digestion of biodegradable waste. Embodiments of the subject matter described herein can be implemented in new installations as well as retrofitted to existing anaerobic digestion facilities such as the one schematically illustrated in FIG. 1 and described above.

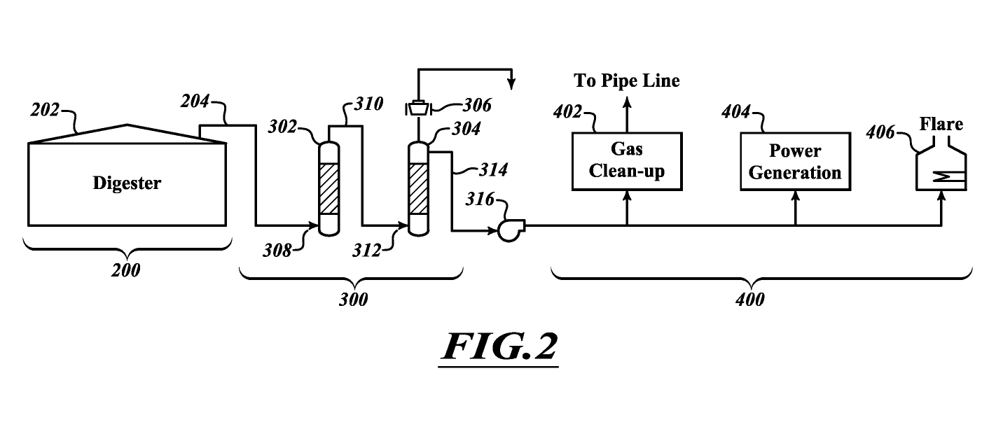

Referring to FIG. 2, a process flow diagram for an embodiment of processes for removing hydrogen sulfide from biogas is illustrated. The illustrated process can be divided into three subparts. Digestion subpart 200, includes anaerobic digester 202. Hydrogen sulfide removal subpart 300, which includes hydrogen sulfide treating stages 302 and 304. Post cleanup subpart 400 which includes one or more of gas cleanup stage 402, power generation stage 404 and combustion stage 406.

In operation, biodegradable waste is delivered to anaerobic digester 202 which is operated under conditions that promote the breakdown of the biodegradable materials under anaerobic conditions. The biodegradable materials may come from many different sources, such as municipal sewage systems and waste streams from industrial processes, e.g., food processing and beverage processing. The processes and systems described herein are not limited to removing hydrogen sulfide gas from biogas resulting from the anaerobic digestion of biodegradable materials originating from a specific source. It is understood that the processes and systems described herein are useful in removing hydrogen sulfide gas from biogas resulting from the anaerobic digestion of biodegradable materials originating from sources other than those specifically described above. Anaerobic digestion relies on microorganisms breaking down biodegradable materials in the absence of oxygen and results in a digestate that includes solids and a biogas that includes methane, carbon dioxide and traces of other contaminant gases, including hydrogen and hydrogen sulfide.

In the embodiment illustrated in FIG. 2, digester 202 does not include a PSV. For reasons that will become more apparent below, digesters utilized in combination with the embodiments described herein for removing hydrogen sulfide from biogas preferably do not include a PSV. Omitting a PSV on the digester is a preferred implementation, because omitting a PSV avoids the possibility of unwanted venting of untreated biogas from the digester containing levels of hydrogen sulfide above levels allowed by regulatory agencies. It is understood that embodiments of the subject matter described herein can also be implemented/retrofitted into existing anaerobic digestion facilities having digesters that include a PSV, the subject matter described herein is not limited to utilization with anaerobic digesters that do not include PSVs.

In the embodiment of FIG. 2, hydrogen sulfide removal subpart 300 includes hydrogen sulfide treating stage 302 and hydrogen sulfide treating stage 304. In the embodiment of FIG. 2, hydrogen sulfide treating stage 304 includes a PSV 306. Biogas exits digester 202 via line 204 and is delivered to an inlet of hydrogen sulfide treating stage 302. The biogas is treated in hydrogen sulfide treating stage 302 to remove hydrogen sulfide. Treated biogas exits hydrogen sulfide treating stage 302 via line 310 and is delivered to inlet 312 of hydrogen sulfide treating stage 304 where the treated biogas is further treated to remove additional hydrogen sulfide. Treated biogas exits hydrogen sulfide treating stage 304 via line 314 and is delivered to the inlet of pump 316 which delivers the treated biogas to post clean up subpart 400 where the treated biogas is processed by gas cleanup stage 402, power generation stage 404 or burned at flare 406. Alternatively, the pressure drop through the scrubber vessel can be maintained at a level low enough so that the pump is not needed. Exemplary pressure drops through the scrubber vessel that would be sufficient to remove the need for pump 316 include less than about 5 inches of water and less than about one inch of water. As

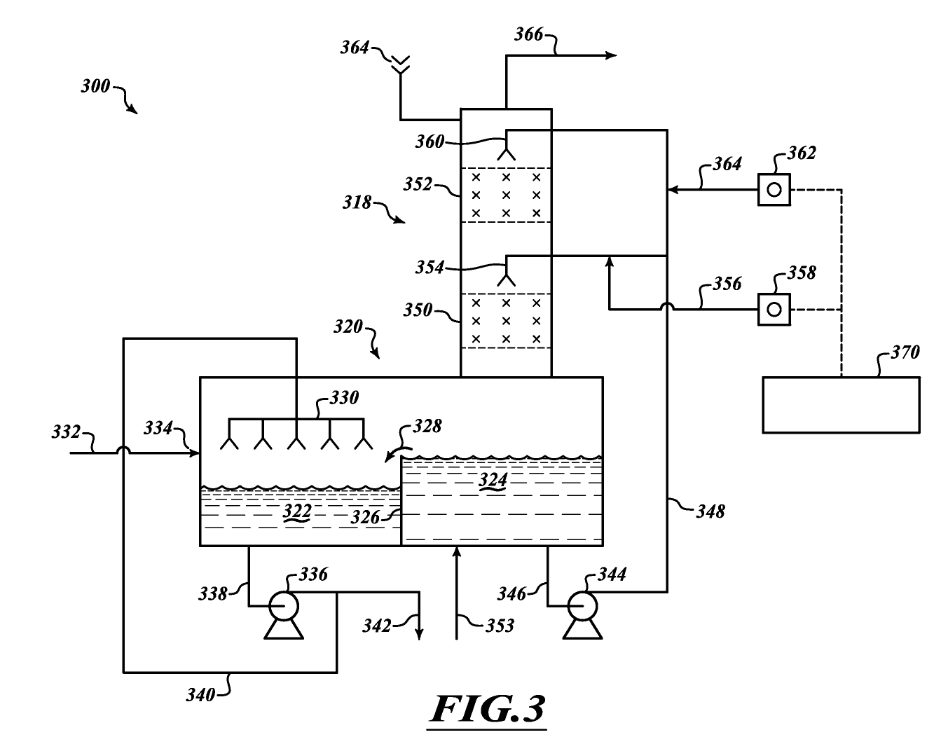

Referring to FIG. 3, hydrogen sulfide removal subpart 300 includes scrubbing vessel 318 and scrubbing solution collector 320. Scrubbing vessel 318 is a single or multi-stage device used to remove contaminants from gases. Such type of devices are commonly referred to as scrubbers characterized as wet scrubbers (using a scrubbing solution to remove contaminants from gas) and dry/semi dry scrubbers which remove contaminants without saturating the contaminant containing gas with a scrubbing solution. Suitable scrubbers also include scrubbers use biological processes to remove hydrogen sulfide. Though not illustrated, suitable scrubbers can be followed by a fixed media such as an iron sponge or activated carbon filters or other fixed media to remove additional sulfides or other unwanted components in the biogas. The following description of embodiments described herein refers to a wet scrubber; however, the embodiments described herein are not limited to use of a wet scrubber and maybe utilized with scrubbers that are not web scrubbers.

Scrubbing solution collector 320 is vessel or tank in fluid communication with scrubbing vessel 318. Scrubbing solution collector 320 can be integral with the scrubbing vessel 318 or it can be a distinct component in fluid communication with scrubbing vessel 318. Scrubbing solution collector 320 is commonly referred to as a sump and serves to collect scrubbing solution that has flowed through scrubbing vessel 318. Scrubbing solution collector 320 illustrated in FIG. 3 is separated laterally into a first zone 322 and a second zone 324 by a weir 326. In the illustrated embodiment, second zone 324 is located beneath scrubbing vessel 318 which facilitates collection of scrubbing solution in second zone 324 after the scrubbing solution has passed through scrubbing vessel 318. First zone 322 and second zone 324 each include an upper portion and a lower portion. The lower portions of first zone 322 and second zone 324 contain collected scrubbing solution. The upper portions of first zone 322 and second zone 324 serve as head space for hydrogen sulfide containing biogas. The level of collected scrubbing solution in first zone 322 is maintained below the top of weir 326. The level of collected scrubbing solution in second zone 324 is maintained at or above the top of weir 326. When the level of collected scrubbing solution in second zone 324 is above the top of weir 326, collected scrubbing solution in second zone 324 passes over the top of weir 326 and into first zone 322 as indicated by arrow 328. Weir 326 prevents collected scrubbing solution in first zone 322 from flowing into second zone 324.

Hydrogen sulfide containing biogas in line 332 is introduced into the upper portion of first zone 322 via inlet 334. The introduced hydrogen sulfide containing biogas travels laterally through the upper portion of first zone 322, over weir 326 and into the upper portion of second zone 324. From the second zone 324, the biogas enters the bottom of scrubbing vessel 318. First zone 322 includes a scrubbing solution dispersing device 330 located in the upper portion of first zone 322. Scrubbing solution dispersing device 330 receives collected scrubbing solution and disperses collected scrubbing solution throughout the upper portion of the first zone 322. Scrubbing solution dispersing device 330 can be any known device for dispersing a scrubbing solution into a gas, including spray bars, spray nozzles, misters, and mechanically induced spray generators. The particular device utilized as a scrubbing solution dispersing device is not limited to the devices listed above and can be a device other than those listed above. Scrubbing solution dispersing device 330 is fed by pump 336 which receives collected scrubbing solution from the lower portion of the first zone 322 via line 338. Pump 336 delivers the collected scrubbing solution to scrubbing solution dispersing device 330 via line 340. Line 340 is in fluid communication with line 342 which serves as a blowdown for sending collected scrubbing solution to waste. When hydrogen sulfide containing biogas is present in first zone 322, the scrubbing solution dispersing device 330 disperses the collected scrubbing solution throughout the biogas under conditions that promote the removal of hydrogen sulfide from the biogas. After contact with the dispersed collected scrubbing solution in first zone 322, the treated biogas enters upper portion of the second zone 324. From the upper portion of second zone 324, the biogas enters the bottom of scrubber vessel 318.

The lower fluid containing portion of second zone 324 is in fluid communication with pump 344 which serves to deliver collected scrubbing solution from second zone 324 to scrubbing vessel 318 via lines 346 and 348.

Scrubbing vessel 318 illustrated in FIG. 3 includes a first stage 352 and a second stage 350 located below the first stage 352. Hydrogen sulfide containing biogas from second zone 324 enters the bottom of scrubbing vessel 318 and passes upward through second stage 350 before passing through first stage 352. While the scrubbing vessel 318 is illustrated in FIG. 3 as a single vessel or column containing multiple stages, it is understood that a single stage instead of multiple stages could be used and that if multiple stages are used, they can be provided utilizing multiple vessels such as illustrated in FIG. 2. In addition, it is understood that fewer or more than two stages may be employed in accordance with embodiments described herein.

First stage 352 is a media bed containing media designed to increase the contact efficiency between the scrubbing solution and the biogas. Exemplary media includes conventional media used in packed beds and conventional scrubbers, such as raschig rings, and media sold under the brand names Tri-Pak and Lanpak. Media other than those listed above can be used in embodiments described herein and the embodiments described herein are not limited to use of the media listed above. Scrubbing vessel 318 includes a second scrubbing solution dispersing device 354 above second stage 350. Second scrubbing solution dispersing device 354 is capable of receiving collected scrubbing solution from line 348. In addition, scrubbing solution dispersing device 354 is capable of receiving fresh scrubbing solution via line 356 from fresh scrubbing solution source 358. In a similar fashion, scrubbing vessel 318 includes a first scrubbing solution dispersing device 360 capable of receiving collected scrubbing solution via line 348 and fresh scrubbing solution from fresh scrubbing solution source 362 via line 364. First scrubbing solution dispersing device 360 and second scrubbing solution dispersing device 354 are of a conventional design and include dispersing devices of the type described above with respect to scrubbing solution dispersing device 330 in first zone 322 of scrubbing solution collector 320.

Scrubbing vessel 318 also includes a pressure release device 364 (PSV) above second stage 352 adjacent the scrubber discharge 366. The PSV on scrubbing vessel 318 is placed at the scrubber discharge and has a set pressure which in the event of an over pressurization event in the digester, protects the digester from an over pressurization condition that could damage the digester. Any biogas vented through the scrubber PSV has been scrubbed and treated to remove hydrogen sulfide down to levels below those permitted for release of hydrogen sulfide to the environment, typically less than 600 ppm and greater than 20 ppm. Venting biogas through a PSV on the digester that is not using ferrous chloride or other means to reduce the hydrogen sulfide content of the biogas within the digester would result in venting biogas gas having a hydrogen sulfide content greater than the permitted discharge limits. Thus, in some embodiments, the PSV on the discharge side of the scrubber is be relied upon to protect the digester from an over pressurization event. In other embodiments, when the digester includes a PSV, the PSV on the discharge side of the scrubber can still be relied upon to protect the digester from an over pressurization event by utilizing a PSV on the scrubber vessel 318 that has a set pressure below the set pressure of the digester PSV. When the set pressure of the scrubber vessel PSV is less than the set pressure of the digester PSV, the scrubber vessel PSV will vent before the set pressure on the digester is reached, thus effectively protecting the digester from an over pressurization condition to the same extent as embodiments where no PSV is provided on the digester. Because the biogas vented via the PSV on the discharge side of the scrubber has been treated to remove hydrogen sulfide, violation of regulatory limits can be avoided.

Continuing to refer to FIG. 3, systems and processes described herein are carried out in a counter-flow manner with the gas phase comprising the hydrogen sulfide containing biogas flowing counter to the liquid phase comprising the scrubbing solution. More specifically, hydrogen sulfide containing biogas enters the headspace in scrubbing solution collector 320, passes laterally through first zone 322 before passing laterally through second zone 324 and then upward through scrubbing vessel 318. Within scrubbing vessel 318, the biogas passes first through second stage 350 before passing through first stage 352 and out scrubbing vessel 318 discharge 366. A combination of fresh scrubbing solution (from fresh scrubbing solution source 362) and collected scrubbing solution from second zone 324 may be dispersed within scrubbing vessel 318 above first stage 352 by first scrubbing solution dispersing device 360. This introduced combination of scrubbing solutions flows through scrubbing vessel 318 in a direction counter to the direction the hydrogen sulfide containing biogas flows through scrubbing vessel 318. Another combination of fresh scrubbing solution (from fresh scrubbing solution source 358) and collected scrubbing solution from second zone 324 may be dispersed within scrubbing vessel below first stage 352 and above second stage 350 by second scrubbing solution dispersing device 354. These introduced combinations of scrubbing solutions flow through scrubbing vessel 318 in a direction counter to the direction the hydrogen sulfide containing biogas flows through scrubbing vessel 318. While the description above refers to introduction of a combination of fresh scrubbing solution and collected scrubbing solution, it is understood that fresh scrubbing solution alone or collected scrubbing solution alone can be dispersed above the first stage 352 and/or the second stage 350.

Scrubbing solution that flows through scrubbing vessel 318 is collected in scrubbing solution collector 320 and more specifically, in second zone 324 of the scrubbing solution collector 320. When the level of collected scrubbing solution in second zone 324 reaches the top of weir 326, the collected scrubbing solution flows in the direction of arrow 328 into first zone 322 of scrubbing solution collector 320. The portion of the collected scrubbing solution from second zone 324 that flows into the first zone 322 is referred to as the nonrecycled portion because such collected scrubbing solution is not recycled to scrubbing vessel 318. The portion of collected scrubbing solution that remains in second zone 324 is referred to as the recycle portion because such collected scrubbing solution is recycled to scrubbing vessel 318. This flow of collected scrubbing solution within scrubbing solution collector 320 is in a direction that is counter to the direction that the hydrogen sulfide containing biogas introduced into scrubbing solution collector 320 at inlet 334 flows through scrubbing solution collector 320. As described above, first zone 322 includes a scrubbing solution dispersing device 330 which disperses collected scrubbing solution within hydrogen sulfide containing biogas in first zone 322 thus providing a third stage of contact between the hydrogen sulfide containing biogas and the scrubbing solution. This collected scrubbing solution dispersed within first zone 322 includes collected scrubbing solution that has flowed into first zone 322 from second zone 324 and scrubbing solution that has been collected from first zone and dispersed into the hydrogen sulfide containing biogas by scrubbing solution dispersing device 330. As noted above, scrubbing solution collector 320 is configured so that collected scrubbing solution that contacts the hydrogen sulfide containing biogas in first zone 322 does not flow back into second zone 324. Isolating the collected scrubbing solution in first zone 322 from the collected scrubbing solution in second zone 324 is desired for the reasons described in the following paragraphs.

While specific embodiments of the subject matter described herein are described below with reference to nitrogen containing scrubbing solutions that include compounds formed from aromatic nitrogen heterocyclic compounds (e.g., triazine), it is understood that the described embodiments can utilize other types of scrubbing solutions and that the embodiments described herein are not limited to the use of aromatic nitrogen heterocyclic compound containing scrubbing solutions. For example, scrubbing solutions that utilize caustic, bleach, chlorine dioxide, hydrogen peroxide or ozone can be utilized in accordance with embodiments described herein. Embodiments of the subject matter described herein are described below with reference to scrubbing solutions that contain aromatic nitrogen heterocyclic compound such as those identified below with reference to the chemical structures as a triazine based compounds, thiadiazine based compounds and dithiazine based compounds where R is alkyl, alkyl alcohol or hydrogen. Specific examples of these compounds include triazine, hexahydro-1,3,5-tris(2-hydroxyethyl)-s-triazine, thiadizaine, a thiadiazine based compound where R is hydroxy ethyl (e.g., one substitution of sulfur for an N—R moiety of 1,3,5-tris(2-hydroxyethyl)-s-triazine), dithiazine, and a thiadiazine based compound where R is hydroxyl ethyl (e.g., substitution of sulfur for each of two N—R moiety of 1,3,5-tris(2-hydroxyrhtyl)-s-triazine). It should be understood that embodiments of the subject matter described herein can utilize nitrogen containing compounds such as alkaline amines including monomethylamine, diethanolamine, triethanolamine, triazine derivatives, and condensation reaction products of aldehydes and that the embodiments described herein are not limited to systems and processes that use scrubbing solutions containing the materials described above.

Triazine is heterocyclic amine compound whose molecular formula is C₃H₃N₃. Triazine has three isomeric forms, 1,2,3-triazine, 1,2,4-triazine and 1,3,5-triazine or s-triazine. In preferred embodiments the scrubbing solution contains hexahydro-1,3,5-tris(2-hydroxyethyl)-s-triazine, an aromatic nitrogen heterocyclic compound. Aqueous solutions of hexahydro-1,3,5-tris(2-hydroxyethyl)-s-triazine react with hydrogen sulfide to form thiadiazine, di-thiazine and/or tri-thiane based compounds as shown below. The particular compound formed depends on the degree that nitrogen atoms in the heterocyclic ring are substituted with sulfur atoms. When one nitrogen atom is substituted with one sulfur atom, a thiadiazine based compound is formed. When two nitrogen atoms are each replaced by a sulfur atom, a di-thiazine based compound is formed. When three nitrogen atoms are each replaced by a sulfur atom, a tri-thiane based compound is produced. These substitution reactions of the aromatic nitrogen heterocyclic compound with sulfide from hydrogen sulfide are characterized by different activation energies. When one nitrogen atom is substituted with one sulfur atom and a thiadiazine based compound is formed the activation energy is E1. When two nitrogen atoms are each replaced by sulfur atom and a di-thiazine based compound is formed the activation energy is E2. When three nitrogen atoms are each replaced by a sulfur atom and tri-thiane is produced the activation energy is E3. Activation energies E1, E2 and E3 are different with E1<E2<E3. The substitution reactions are summarized below.

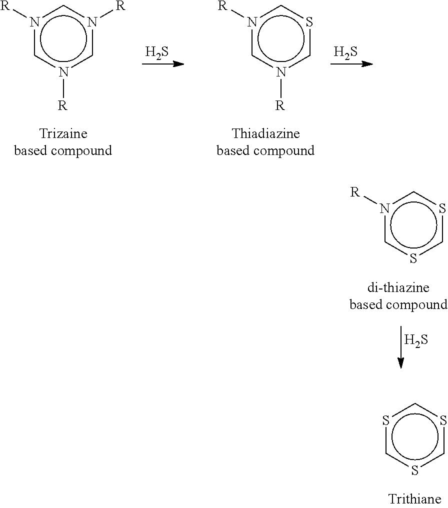

where R is alkyl, alkyl alcohol, or hydrogen.

In accordance with embodiments described herein, the degree of substitution of the aromatic nitrogen heterocyclic compound in the scrubbing solution is affected by the conditions in each stage of the scrubber vessel. Preferably, the operating conditions of each stage are controlled to achieve the desired degree of substitution of the aromatic nitrogen heterocyclic compound in the scrubbing solution. For example, the conditions at which the first stage 352 is operated and second stage 350 is operated can be chosen so sulfur atoms replace at least one and preferably at least two nitrogen atoms of the aromatic nitrogen heterocyclic compound. The degree of the substitution of sulfur for nitrogen in the aromatic nitrogen heterocyclic compound can be effected and controlled by adjusting a number of factors including the liquid to gas ratio in first stage 352, the liquid to gas ratio in the second stage 350 and the amount of fresh scrubbing solution introduced to the first and second stage via lines 356 and 364 respectively. Higher liquid to gas ratios (L/G ratio) result in more contact time between the scrubbing solution and biogas compared to lower L/G ratios. The longer contact times drive a greater degree of substitution of sulfur atoms for nitrogen atoms of the aromatic nitrogen heterocyclic compound compared to shorter contact times. Effective scrubbing of hydrogen sulfide from the biogas requires the hydrogen sulfide gas not only be absorbed into the scrubbing solution (as controlled by Henry's law) but also that the hydrogen sulfide gas be ionized to HS⁻ which then reacts with the aromatic nitrogen heteorcyclic compound. This ionization is important because absorption of hydrogen sulfide gas into the scrubbing solution and ionization to HS⁻ is necessary in order for the substitution reaction that effectively removes sulfur atoms to occur. If the hydrogen sulfide gas does not stay in solution or if it is not ionized and consumed in a reaction with the aromatic nitrogen heterocyclic compound, it will eventually be released to the gas phase, e.g., at the exit of the scrubber vessel. Ionization of hydrogen sulfide is pH dependent and below a pH of about 7 is low, which affects the rate of the reaction that results in the substitution of sulfur atoms into the aromatic nitrogen heterocyclic compounds. When the ionization of hydrogen sulfide gas is low, the reaction rate between HS⁻ and an aromatic nitrogen heterocyclic compound is low. To address these low ionization rates and low reaction rates resulting from operating at ph values below about 9, below about 8, below about 7 or below about 6, in an amine treating system with high levels of carbon dioxide present in a biogas (where equilibrium dictates that the ph could be as low as 6) the embodiments described herein utilize liquid to gas ratios substantially higher than liquid to gas ratios of 2 to 3 of traditional scrubber designs. For example, liquid to gas ratios of greater than about 5 are useful in the embodiments described herein, with L/G ratios ranging from about 5 to about 100 or more being suitable. At these L/G ratios, the concentration of hydrogen sulfide gas in the scrubbing solution may be lower compared to the concentration of hydrogen sulfide gas in a scrubbing solution when the L/G is about 2 to 3; however, the total amount of hydrogen sulfide gas retained in the scrubbing solution will be greater. In accordance with embodiments described herein, hydrogen sulfide gas containing scrubbing solution is collected and retained in the collected scrubbing solution collector for a time sufficient to allow the ionized hydrogen sulfide gas to react with the aromatic nitrogen heterocyclic compounds resulting in substitution of sulfur atoms for nitrogen atoms. By operating the scrubbing system in this manner to achieve two to three sulfur substitutions of the aromatic nitrogen heterocyclic compound, over-feed of scrubbing chemicals because only the first substitution is achieved and utilized to remove sulfur can be avoided. These same results can be achieved in air scrubbers where the biogas may be treated to a low level of sulfide discharge resulting in an equilibrium pH of 8 or less. Utilizing higher L/G ratios to drive a greater degree of substitution provides a means to achieve desired levels of sulfur removal at low pH levels that can be encountered when the biogas contains high levels of carbon dioxide. When pH levels in first stage 352 and/or second stage 350 are below about 9, e.g., below about 7 or below about 6, L/G ratios above about 5, above about 10 and above about 20 provide a means to overcome the low rate of sulfur substitution of the aromatic nitrogen heterocyclic compound resulting from the low level of hydrogen sulfide ionization in the scrubbing solution. Lower L/G ratios result in less contact time and lower degrees of sulfur substitution although this reduced substitution can be countered by operating in the upper ranges of the pH ranges noted above. Increasing the amount of fresh scrubbing solution introduced into the scrubbing vessel, drives the reaction in favor of single substitutions of the aromatic nitrogen heterocyclic compound in the scrubbing solution due to the increasing amount of unsubstituted aromatic nitrogen heterocyclic compound in the scrubbing solution. Conversely, decreasing the amount of fresh scrubbing solution introduced into the scrubbing vessels favors double substitutions of the aromatic nitrogen heterocyclic compound in the scrubbing solution. Delivery of fresh scrubbing solution from fresh scrubbing solution sources 358 and 362 can be controlled by a controller 370 based on inputs, such as hydrogen sulfide gas concentration at the top of the scrubbing vessel or line 366. Preferably, the combination of the L/G ratio and the amount of fresh scrubbing solution introduced into scrubbing vessel 318 are controlled so that the scrubbing solution collected from scrubbing vessel 318 in second zone 324 of scrubbing solution collector 320 is rich in di-thiazine based compounds and thiadiazine based compounds. Controlling the sulfur substitution so single and double substitutions predomination reduces the amount of trithiane (triple substitutions) that is formed in scrubbing vessel 318 and second zone 324 of the scrubbing solution collector 320. The presence of trithiane in scrubbing vessel 318 and the second zone 324 of the scrubbing solution collector 320 is not desired because trithiane is insoluble in water. Water insoluble components in scrubbing vessel 318 can result in fouling of the media included in first stage 352 and second stage 350 as well as the hardware of the scrubbing vessel 318.

On the other hand, di-thiazine based compounds have the ability to remove additional amounts of sulfur from hydrogen sulfide containing biogas through an additional substitution of a sulfur atom for the remaining nitrogen atom.

In the embodiments described with reference to FIG. 3, while complete substitution of the aromatic nitrogen heterocyclic compound is preferably inhibited in the first stage 352 and second stage 350 of the scrubbing vessel 318 and the second zone 324, formation of potentially fouling trithiane in the first zone 322 is of less concern because first zone 322 does not include media that could be fouled by the trithiane. Therefore, in order to take advantage of the ability of the collected scrubbing solution in first zone 322 to remove additional sulfur from the biogas, first zone 322 utilizes the collected scrubbing solution dispersing device 330 as a third stage for contacting the scrubbing solution rich in di thiazine based compounds with the hydrogen sulfide containing biogas and removing an initial amount of sulfur via the formation of the three times substituted tri-thiane. The formed tri-thiane is removed from the first zone 322 via line 342. The dia-thiazine based compound which is substituted with an additional sulfur atom in first zone 322 and removed via line 342 is replenished by dia-thiazine based compound from second zone 324.

Referring to FIG. 2, hydrogen sulfide removal subpart 300 can include hydrogen sulfide treating stages utilizing scrubbing solutions that contain active agents other than aromatic nitrogen heterocyclic compounds. For example, hydrogen sulfide treating stage 302 can utilize caustic as a scrubbing solution and hydrogen sulfide treating stage 304 can utilize a different scrubbing solution such as a scrubbing solution containing an aromatic nitrogen heterocyclic compound. In the embodiment illustrated in FIG. 2, hydrogen sulfide treating stage 302 is controlled to operate at a pH level of less than about 11. The use of caustic at these pH levels allows the caustic to be used as a less expensive sulfide pretreatment without scrubbing substantial amounts of carbon dioxide. When caustic is used in hydrogen treating stage 302, hydrogen sulfide levels in the biogas can be reduced to about 100 ppm. This caustic treatment can then be followed by an amine treatment described above to reduce the sulfur for content of the biomass to a lower desired amount.

Specific operating conditions for the embodiments described with reference to FIG. 3 are provided below; however, it is understood that embodiments described herein are not limited to operating within these described operating conditions. Other operating conditions will provide desired removal of hydrogen sulfide from biogas and control of the removal process. Gas flow rates through the hydrogen sulfide removal subpart 300 are generally less than about 400 standard cubic feet per minute/ft² and the liquid/gas ratio ranges from about five to about 100. Exemplary pressure drops through the hydrogen sulfide removal subpart 300 are less than about 5 inches of water and preferably less than about 1 inch of water. Pressure drops through the hydrogen sulfide subpart 300 below about 5 inches of water ensure that the pressure in hydrogen sulfide subpart 300 is not high as to functionally isolate (i.e., act like a plug between the digester and PSV 364) the PSV 364 of a scrubbing vessel 318 from digester 202. Avoiding functional isolation of the PSV 364 of the scrubbing vessel 318 from digester 202 ensures that the digester is effectively protected from an over pressurization event by PSV 364 of the vessel 318. If the pressure within the hydrogen sulfide subpart 300 is too high, the PSV 364 will not sense the pressure buildup in digester 202 and will not vent when the pressure in the digester exceeds desired levels.

The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system for removing hydrogen sulfide from a hydrogen sulfide containing biogas resulting from an anaerobic digestion of waste containing biodegradable materials, the system comprising:
a vessel including an inlet for receiving hydrogen sulfide containing biogas resulting from an anaerobic digestion of waste containing biodegradable materials, at least one media bed, at least one inlet for receiving a scrubbing solution, a pressure relief device, and an outlet for exhausting treated biogas; and
a scrubbing solution collector and including a scrubbing solution dispersion device, the collector including a first zone including the scrubbing solution dispersion device where hydrogen sulfide containing biogas produced by an anaerobic digestion of waste containing biodegradable materials is contacted with dispersed scrubbing solution, the collector further including a second zone in fluid communication with the vessel and in fluid communication with the first zone.

2. The system of claim 1, where the pressure relief device has a set pressure that is at least about 1 inch of water less than a set pressure for a pressure relief device for a digester in which the anaerobic digestion that results in the hydrogen sulfide containing biogas occurs.

3. The system of claim 1, wherein the scrubbing solution includes at least one aromatic nitrogen heterocyclic compound.

4. The system of claim 3, wherein the aromatic nitrogen heterocyclic compound is selected from a triazine-based compound, a thiadiazine-based compound and a dithiazine based compound.

5. The system of claim 3, wherein the aromatic nitrogen heterocyclic compound is hexahydro-1,3,5-tris(2-hydroxyethyl)-s-triazine.

6. The system of claim 1, wherein pressure drop across the vessel ranges from less than about 1 of water to about 5 inches of water.

7. The system of claim 1, further comprising a scrubbing solution recycle from the second zone to the vessel.

8. A method for removing hydrogen sulfide from a hydrogen sulfide containing biogas resulting from an anaerobic digestion of waste containing biodegradable materials, the method comprising the steps of:
receiving in a vessel, a hydrogen sulfide containing biogas resulting from anaerobic digestion of waste containing biodegradable materials;
introducing into the vessel a scrubbing solution;
contacting the biogas with the scrubbing solution;
removing treated biogas from the vessel; and
venting treated biogas from the vessel.

9. The method of claim 8, wherein the venting occurs when pressure in the vessel is at least about one inch of water less than pressure in a reactor in which the anaerobic digestion that results in the hydrogen sulfide containing biogas occurs.

10. The method of claim 8, wherein the introducing step further comprises introducing at least one aromatic nitrogen heterocyclic compound.

11. The method of claim 10, wherein the aromatic nitrogen heterocyclic compound is selected from a triazine-based compound, a thiadiazine-based compound and a dithiazine based compound.

12. The method of claim 10, wherein the aromatic nitrogen heterocyclic compound is hexahydro-1,3,5-tris(2-hydroxyethyl)-s-triazine.

13. The method of claim 8, further comprising collecting scrubbing solution from the vessel in a scrubbing solution collector and contacting the collected scrubbing solution with the hydrogen sulfide containing biogas resulting from the anaerobic digestion.

14. The method of claim 13, further comprising recycling collected scrubbing solution from the scrubbing solution collector to the vessel.

15. The method of claim 13, further comprising separating the collected scrubbing solution into a recycled portion and a non-recycled portion.

16. The method of claim 15, further comprising dispersing the non-recycled portion of collected scrubbing solution within the hydrogen sulfide containing biogas resulting from the anaerobic digestion prior to receiving the hydrogen sulfide containing biogas into the vessel.

17. The method of claim 8, wherein the liquid to gas ratio in the vessel ranges from about 5 to about 100.

18. A method for relieving pressure in a process for the anaerobic digestion of waste containing biodegradable materials, the method comprising the steps of:
receiving in a vessel, a hydrogen sulfide containing biogas resulting from an anaerobic digestion of waste containing biodegradable materials;
introducing a scrubbing solution into the vessel;
contacting the biogas with the scrubbing solution;
removing treated biogas from the vessel; and
venting treated biogas from the vessel.

19. The method of claim 18, wherein the venting occurs when pressure in the vessel is at least about one inch of water less than pressure in a reactor in which the anaerobic digestion that results in the hydrogen sulfide containing biogas occurs.

20. The method of claim 18, wherein the introducing step further comprises introducing at least one aromatic nitrogen heterocyclic compound.

21. The method of claim 20, wherein the aromatic nitrogen heterocyclic compound is selected from a triazine-based compound, a thiadiazine-based compound and a dithiazine based compound.

22. The method of claim 20, wherein the aromatic nitrogen heterocyclic compound is hexahydro-1,3,5-tris(2-hydroxyethyl)-s-triazine.

23. The method of claim 18, further comprising collecting scrubbing solution from the vessel in a scrubbing solution collector and contacting the collected scrubbing solution with the hydrogen sulfide containing biogas produced by the anaerobic digestion.

24. The method of claim 23, further comprising recycling collected scrubbing solution from the scrubbing solution collector to the vessel.

25. The method of claim 23, further comprising separating the collected scrubbing solution into a recycled portion and a non-recycled portion.

26. The method of claim 25, further comprising dispersing the non-recycled portion of collected solution with the hydrogen sulfide containing biogas resulting from the anaerobic digestion prior to receiving the hydrogen sulfide containing biogas into the vessel.

27. The method of claim 18, wherein the liquid to gas ratio in the vessel ranges from about 5 to about 100.
